(19) United States
(12) Patent Application Publication
(10) Pub. No.: US 2010/0105543 A1
(43) Pub. Date: Apr. 29, 2010

(54) PREPARATION METHOD OF A SOLID TITANIUM CATALYST FOR OLEFIN POLYMERIZATION

(75) Inventors: Chun-Byung Yang, Daejon (KR); Joon-Ryeo Park, Seoul (KR)

Correspondence Address: YOUNG & THOMPSON, 209 Madison Street, Suite 500, Alexandria, VA, 22314, US

(73) Assignee: SAMSUNG TOTAL PETROCHEMICALS CO., LTD, Seosan-shi, Chungcheongnam-do (KR)

(21) Appl. No.: 12/530,280

(22) PCT Filed: Oct. 31, 2007
(86) PCT No.: PCT/KR07/05464

§ 371 Date: Dec. 28, 2009

(30) Foreign Application Priority Data
Mar. 28, 2007 (KR) 10-2007-0030326

(51) Int. Cl. C08F 4/654

(52) U.S. Cl. 502/107

(57) ABSTRACT

A preparation method of a solid titanium catalyst for olefin polymerization characteristically comprises the steps of: (1) obtaining a magnesium compound solution by dissolving a magnesium halide compound in an oxygen-containing solvent that is a mixed solvent of a cyclic ether and at least one of alcohols; (2) preparing a carrier by primarily reacting the obtained magnesium compound solution with a titanium halide compound at −10-30° C., then raising a temperature or aging so as to obtain particles, and secondly reacting the particles with a titanium halide compound; (3) preparing a catalyst by reacting the carrier with a titanium halide compound and an electron donor of phthalic acid dialkylester having a C9-13 alkyl group; and (4) washing the prepared catalyst with a hydrocarbon solvent at 40-200° C.

### TECHNICAL FIELD

The present invention relates to a preparation method of a solid titanium catalyst for olefin polymerization, more specifically, to a preparation method of a solid titanium catalyst for olefin polymerization which has a uniform spherical shape, excellent catalyst activity and hydrogen reactivity, and high stereoregularity. Further, polymers prepared by using the catalyst have a small amount of xylene solubles.

### BACKGROUND ART

So far, many catalysts for olefin polymerization and polymerization methods using the same have been reported. However, efforts have been made to improve the physical properties of polymers obtained by using such designed catalysts so as to increase the productivity and product quality, in order to raise the commercial significance of a catalyst. Further, there still have been demands for improvement in the activity and stereospecificity of a catalyst per se.

Titanium-based catalysts for olefin polymerization which contains magnesium, and methods for preparing such catalysts, particularly, methods for preparing a catalyst using a magnesium compound solution for adjusting the particle shape and size of the catalyst have been reported many in this field of art.

For obtaining such magnesium compound solution, there are methods of reacting a magnesium compound with an electron donor such as an alcohol, amine, ether, ester, carboxylic acid and the like, in the presence of a hydrocarbon solvent. Examples of a method using an alcohol are described in U.S. Pat. Nos. 4,330,649 and 5,106,807, and Japanese laid-open patent publication Sho58-83006. Moreover, U.S. Pat. Nos. 4,315,874, 4,399,054 and 4,071,674 also report methods of preparing a magnesium solution.

Tetrahydrofuran, which is a cyclic ether, has been variously used as a solvent for magnesium chloride compound (for example, U.S. Pat. No. 4,482,687), an additive of a cocatalyst (U.S. Pat. No. 4,158,642), and a solvent (U.S. Pat. No. 4,477,639).

U.S. Pat. Nos. 4,347,158, 4,422,957, 4,425,257, 4,618,661 and 4,680,381 suggest a method for preparing a catalyst by adding a Lewis acid compound such as aluminum chloride to a support, magnesium chloride, and then milling the mixture.

However, although the above-mentioned patents have been improved in terms of a catalyst activity, there are still problems such that the shape, size and size distribution of a catalyst are irregular, and the stereoregularity should be further improved.

U.S. Pat. No. 5,360,776 discloses a catalyst obtained by reacting a magnesium chloride-ethanol complex carrier with dialkyl phthalate having 10 carbon atoms as an electron donor. It insists that thus obtained catalyst shows higher activity, however any mention regarding stereoregularity as well as hydrogen reactivity are not found. There are many cases that the hydrogen reactivity is mostly often a major requisite of a catalyst at the time of producing a certain polypropylene product through a polymerization process. Therefore, it can be said that a catalyst having such characteristic is preferred.

### DISCLOSURE OF INVENTION

### Technical Problem

As described above, improvement of the commercial value of a catalyst for alphaolefin polymerization is focused on efforts for improving product quality by preparing a catalyst having high polymerization activity and stereoregularity; efforts for increasing the productivity by regulating the shape and size of a catalyst; and efforts for reducing production cost by improving the production yield and activity of a catalyst in catalyst production. Such efforts are being made in this field of art, and improvement in such efforts, as an important factor to a catalyst economy, is in demand.

### Technical Solution

The present invention has been designed to resolve the problems of prior art as mentioned above. Therefore, the objects of the present invention is to provide a preparation method of a solid titanium catalyst for olefin polymerization which has a uniform spherical shape, excellent catalyst activity and hydrogen reactivity, and high stereoregularity, and can produce polymers having a small amount of xylene solubles.

A preparation method of a solid titanium catalyst for olefin polymerization according to the present invention characteristically comprises the steps of:

(1) obtaining a magnesium compound solution by dissolving a magnesium halide compound in an oxygen-containing solvent that is a mixed solvent of a cyclic ether and at least one of alcohols;

(2) preparing a carrier by primarily reacting the obtained magnesium compound solution with a titanium halide compound at −10-30° C., then raising a temperature or aging so as to obtain particles, and secondly reacting the particles with a titanium halide compound;

(3) preparing a catalyst by reacting the carrier with a titanium halide compound and phthalic acid dialkylester having a C9-13 alkyl group as an electron donor; and

(4) washing the prepared catalyst with a hydrocarbon solvent at 40-200° C.

Examples of the magnesium halide compound used in the step (1) include halogenated magnesium, alkyl magnesium halide, alkoxymagnesium halide and aryloxymagnesium halide. The magnesium halide compound may be used as a mixture of two or more species, and also effectively used as a complex compound with other metals.

The cyclic ethers used in the step (1) is preferably a cyclic ether having 3-6 carbon atoms in the ring and derivatives thereof; more preferably tetrahydrofuran and 2-methyl tetrahydrofuran; and most preferably tetrahydrofuran.

The alcohol used in the step (1) is preferably a monohydric alcohol or a polyhydric alcohol of C1-20, and more preferably an alcohol of C2-12.

The amount of said oxygen-containing solvent of the step (1) is 1-15 mol per 1 mol of magnesium atoms in the magnesium halide compound, preferably about 2-10 mol. When the amount is less than 1 mol, the magnesium halide compound hardly dissolves, whereas when it is above 15 mol, the amount of the magnesium halide compound used is excessive large, as well as controls of particles is hardly achieved.

The ratio of the amount of a cyclic ether and an alcohol in the oxygen-containing solvent, is preferably 0.5-3.5 mol of an alcohol per 1 mol of a cyclic ether, however, it can be suitably adjusted, depending on the desired particle properties and dimensions of the resulted catalyst.

The dissolving temperature in the step (1) is, although it may vary according to the species and amount of a cyclic ether and an alcohol used therein, preferably 20-200° C., and more preferably about 50-150° C.

In the step (1), a hydrocarbon solvent may be additionally used as a diluent. As a hydrocarbon solvent, aliphatic hydrocarbons such as pentane, hexane, heptane, octane, decane and kerosene; alicyclic hydrocarbons such as cyclohexane and methylcyclohexane; aromatic hydrocarbons such as benzene, toluene, xylene and ethyl benzene; and halogenated hydrocarbons such as trichloroethylene, carbon tetrachloride and chlorobenzene may be mentioned.

In the step (2), a titanium halide compound represented as the following general formula (I) is primarily added to the magnesium compound solution obtained from the step (1) at −10-30° C. in a way of preventing particle generation, at a molar ratio of the oxygen-containing solvent: the titanium halide compound being 1:3.0-10, and then particles are precipitated by raising the temperature or aging. Thereafter, a titanium halide compound represented as the following general formula (I) is secondly added to the resulted magnesium compound solution for further reaction, at a molar ratio of the oxygen-containing solvent: the titanium halide compound being 1:0.3-7.0, thereby obtaining a carrier:

Ti(OR)ₐX₍₄₋ₐ₎ (I)

wherein, R is a C1-10 alkyl group; X is a halogen atom; and a is an integer of 0-3, which is to meet the atomic valence of the formula.

When primarily adding the titanium halide compound to the magnesium compound solution in the step (2), conditions such as a temperature at the time of addition and a molar ratio between the oxygen-containing solvent and the titanium halide compound may be suitably adjusted to prevent precipitates from being generated, which is important to control the morphology of the resulting carrier. After the generation of carrier particles, the second addition of the titanium halide compound may be conducted for further reaction, thereby increasing the production yield of a catalyst.

The step (3) is a step of impregnating titanium within the carrier by reacting the carrier obtained from the step (2) with the titanium halide compound and an electron donor, i.e. phthalic acid dialkylester having C9-13 alkyl groups. The reaction may be completed through a single reaction, however it is preferred to accomplish the reaction through twice or three times or more of reactions.

Preferably, in the step (3), the carrier obtained from the step (2) is reacted with the titanium halide compound or a suitable electron donor, and slurry remained after separating the liquid portion from the mixture is reacted again with the titanium halide compound and phthalic acid dialkylester as an electron donor. Subsequently, solids are separated from the resulted mixture, and then again reacted with the titanium halide compound or an appropriate electron donor.

As for an electron donor, i.e. phthalic acid dialkylester having C9-13 alkyl groups used in the step (3), dialkyl phthalates such as diisononylphthalate, diisodecylphthalate, di-tert-decylphthalate or the like and derivatives thereof may be mentioned.

The molar ratio of the phthalic acid dialkylester electron donor used in the step (3) and the magnesium halide compound of the step (1) (the magnesium halide compound: phthalic acid dialkylester) is 1:0.08-2.5.

The step (4) is a step of washing the catalyst prepared from the step (3) with a hydrocarbon solvent at a high temperature, through which a highly stereoregular catalyst is completed.

Examples of the hydrocarbon solvent used in the step (4) may include: aliphatic hydrocarbons such as pentane, hexane, heptane, octane, decane and kerosene; alicyclic hydrocarbons such as cyclohexane and methylcyclohexane; aromatic hydrocarbons such as benzene, toluene, xylene and ethyl benzene; and halogenated hydrocarbons such as trichloroethylene, carbon tetrachloride and chlorobenzene.

In order to further increase the stereoregularity of a solid complex titanium catalyst, the washing temperature in the step (4) is 40-200° C., and preferably 50-150° C.

A solid complex titanium catalyst prepared through the foregoing steps (1)-(4), may be used in polymerization of propylene; copolymerization of olefins such as ethylene, propylene, 1-butene, 1-pentene, 4-methyl-1-pentene, 1-hexene or the like; and copolymerization of conjugated or non-conjugated dienes such as polyunsaturated compounds.

### MODE FOR THE INVENTION

The present invention will be understood fully by the following examples, however it should be noted that such examples are only to illustrate the present invention, and they are not to limit the scope of the right sought to be protected by the present invention.

### EXAMPLES

### Example 1

### Preparation of a Solid Titanium Catalyst

Step 1: Preparation of a Magnesium Compound Solution

To a 10L volume reactor equipped with a mechanical stirrer, of which atmosphere was substituted with nitrogen, 300 g of MgCl₂, 4.5 kg of toluene, 350 g of tetrahydrofuran and 600 g of butanol were added, and the temperature was raised to 110° C., while stirring at 550 rpm. It was maintained for 3 hours, thereby obtaining a uniform solution.

Step 2: Preparation of a Carrier

The solution obtained from the step 1 was cooled to 20° C., and thereto 700 g of TiCl₄ was added. Then, the temperature of the reactor was elevated to 60° C. over 1 hour, and when reached to 60° C., 280 g of TiCl was added thereto over 40 minutes and allowed to react for 30 minutes. After the reaction, it was allowed to stand for 30 minutes so as to precipitate carriers and then the upper portion of the solution was removed. The slurry remained in the reactor was subjected to, after addition of 2 kg of toluene, stirring, standing, removal of the supernatant, and the above procedure was repeated 3 times for washing.

Step 3: Preparation of a Catalyst

To the carrier prepared in the above step 2, 2.0 kg of toluene and 2.0 kg of TiCl₄ were added, and then the temperature of the reactor was elevated to 110° C. over 1 hour. The mixture was aged for 1 hour, and stood still for 15 minutes so that solids can be precipitated, and then the supernatant was removed. To the remained slurry, 2.0 kg of toluene, 2.0 kg of TiCl₄ and diisononylphthalate at the amount of 0.09 mol per mol of MgCl₂ used in the step 1 were added. The temperature of the reactor was elevated to 113° C. and maintained for 1 hour for allowing a reaction. After the reaction, the resultant was stood still for 30 minutes and then the supernatant was separated. Then, 2.0 kg of toluene and 2.0 kg of TiCl₄ were added thereto again, and it was allowed to react at 100° C. for 30 minutes. After the reaction, it was stirred for 30 minutes and stood still, and then the supernatant was removed therefrom.

Step 4: Washing

To the catalyst slurry separated from the step 3, 2.0 kg of hexane was added, and the temperature of the reactor was maintained at 40° C. for 30 minutes while stirring. Then, stirring was stopped, and the mixture was maintained still for 30 minutes. The supernatant was removed. The remained catalyst slurry was washed 6 times again in the same way with the addition of hexane, thereby producing the final solid titanium catalyst.

Each particle size distribution of the resulted carrier and the catalyst was determined by using a laser particle size analyzer (Mastersizer X, Malvern Instruments), and the composition of the catalyst was analyzed by ICP.

The catalyst as prepared above was determined to have about 25 [symbol] of an average particle size, and 1.8 wt % of titanium.

### Polymerization

Polymerization of propylene was carried out in order to evaluate the performance of the resulted catalyst. In a glove box under a nitrogen atmosphere, about 7 mg of the prepared catalyst were weighed and placed into a glass bulb. The glass bulb was sealed and installed in a 4L autoclave in a way that the bulb breaks simultaneously with the operation of a stirrer so as to start the reaction. The reactor was purged with nitrogen for about 1 hour so that the atmosphere of the reactor was changed to dry nitrogen. Thereto, triethyl aluminum (molar ratio of Al/Ti=850) and dicyclopentyldimethoxysilane (molar ratio of Si/Al=0.1) as an external electron donor were added, and the reactor was tightly closed. After injecting 1,000 ml of hydrogen and 2,400 ml of liquid propylene by using a syringe pump into the reactor, the glass bulb was broken by beginning stirring so as to initiate a polymerization reaction and at the same time the temperature of the reactor was raised to 70° C. over 20 minutes. The polymerization was carried out for 1 hour. After 1 hour, unreacted propylene was vented out into air, and the temperature of the reactor was cooled down to room temperature. The produced polymers were dried in a vacuum oven at 50° C. and weighed. Thus prepared polypropylene powder was analyzed for xylene solubles and MI (melt index), which are routinely practiced in this field of art. The results were represented in Table 1 shown below.

### Example 2

A catalyst was prepared by the same process as in Example 1, except that 0.09 mol of diisodecylphthalate per mol of MgCl₂ instead of diisononylphthalate was used in the step 3 of the preparation of a solid titanium catalyst in Example 1. The results were shown in Table 1.

### Example 3

A catalyst was prepared by the same process as in Example 1, except that 0.09 mol of di-tert-decylphthalate per mol of MgCl₂ instead of diisononylphthalate was used in the step 3 of the preparation of a solid titanium catalyst in Example 1. The results were shown in Table 1.

### Example 4

A catalyst was prepared by the same process as in Example 1, except that 0.11 mol of diisononylphthalate per mol of MgCl₂ was used in the step 3 of the preparation of a solid titanium catalyst in Example 1. The results were shown in Table 1.

### Example 5

A catalyst preparation and polymerization were carried out by the same processes as in Example 1, except that 0.11 mol of diisononylphthalate per mol of MgCl₂ was used in the step 3 of the preparation of a solid titanium catalyst in Example 1, and 3,000 ml of hydrogen was used in the polymerization process. The results were shown in Table 1.

### Example 6

A catalyst preparation and polymerization were carried out by the same processes as in Example 1, except that 0.11 mol of diisononylphthalate per mol of MgCl₂ was used in the step 3 of the preparation of a solid titanium catalyst in Example 1, and 5,000 ml of hydrogen was used in the polymerization process. The results were shown in Table 1.

### Example 7

A catalyst preparation and polymerization were carried out by the same processes as in Example 1, except that 0.11 mol of diisononylphthalate per mol of MgCl₂ was used in the step 3 of the preparation of a solid titanium catalyst in Example 1, and 7,000 ml of hydrogen was used in the polymerization process. The results were shown in Table 1.

### Example 8

A catalyst was prepared by the same process as in Example 1, except that 0.15 mol of diisononylphthalate per mol of MgCl₂ was used in the step 3 of the preparation of a solid titanium catalyst in Example 1. The results were shown in Table 1.

### Example 9

A catalyst was prepared by the same process as in Example 1, except that 0.20 mol of diisononylphthalate per mol of MgCl₂ was used in the step 3 of the preparation of a solid titanium catalyst in Example 1. The results were shown in Table 1.

### Example 10

A catalyst was prepared by the same process as in Example 1, except that 0.15 mol of diisodecylphthalate per mol of MgCl₂ instead of diisononylphthalate was used in the step 3 of the preparation of a solid titanium catalyst in Example 1. The results were shown in Table 1.

### Example 11

A catalyst was prepared by the same process as in Example 1, except that 0.20 mol of diisodecylphthalate per mol of MgCl₂ instead of diisononyphthalate was used in the step 3 of the preparation of a solid titanium catalyst in Example 1. The results were shown in Table 1.

### Comparative Example 1

A catalyst was prepared by the same process as in Example 1, except that 0.15 mol of diisobutylphthalate per mol of MgCl₂ instead of diisononyphthalate was used in the step 3 of the preparation of a solid titanium catalyst in Example 1. The results were shown in Table 1.

### Comparative Example 2

A catalyst preparation and polymerization were carried out by the same processes as in Example 1, except that 0.15 mol of diisobutylphthalate per mol of MgCl₂ instead of diisononyphthalate was used in the step 3 of the preparation of a solid titanium catalyst in Example 1, and 3,000 ml of hydrogen was used in the polymerization process. The results were shown in Table 1.

### Comparative Example 3

A catalyst preparation and polymerization were carried out by the same processes as in Example 1, except that 0.15 mol of diisobutylphthalate per mol of MgCl₂ instead of diisononyphthalate was used in the step 3 of the preparation of a solid titanium catalyst in Example 1, and 5,000 ml of hydrogen was used in the polymerization process. The results were shown in Table 1.

### Comparative Example 4

A catalyst preparation and polymerization were carried out by the same processes as in Example 1, except that 0.15 mol of diisobutylphthalate per mol of MgCl₂ instead of diisononyphthalate was used in the step 3 of the preparation of a solid titanium catalyst in Example 1, and 7,000 ml of hydrogen was used in the polymerization process. The results were shown in Table 1.

### Comparative Example 5

A catalyst was prepared by the same process as in Example 1, except that 0.20 mol of diisobutylphthalate per mol of MgCl₂ instead of diisononyphthalate was used in the step 3 of the preparation of a solid titanium catalyst in Example 1. The results were shown in Table 1.

### Comparative Example 6

A catalyst was prepared by the same process as in Example 1, except that 0.09 mol of diethylphthalate per mol of MgCl₂ instead of diisononyphthalate was used in the step 3 of the preparation of a solid titanium catalyst in Example 1. The results were shown in Table 1.

### Comparative Example 7

A catalyst was prepared by the same process as in Example 1, except that 0.15 mol of diethylphthalate per mol of MgCl₂ instead of diisononyphthalate was used in the step 3 of the preparation of a solid titanium catalyst in Example 1. The results were shown in Table 1.

### Comparative Example 8

A catalyst was prepared by the same process as in Example 1, except that 0.20 mol of diethylphthalate per mol of MgCl₂ instead of diisononyphthalate was used in the step 3 of the preparation of a solid titanium catalyst in Example 1. The results were shown in Table 1.

TABLE 1

| | | Electron | | | | |
|---|---|---|---|---|---|---|
| | | donor/MgCl₂ | Amount of | Polymerization | | |
| | Electron | (molar | hydrogen | activity | | |
| | donor | ratio) | (CC) | (kgPP/gCat) | XS (%) | MI (g/10 min) |
| Example 1 | DINP | 0.09 | 1000 | 42 | 1.5 | 5.4 |
| Example 2 | DIDP | 0.09 | 1000 | 43 | 1.6 | 5.8 |
| Example 3 | DTDP | 0.09 | 1000 | 38 | 1.6 | 6.2 |
| Example 4 | DINP | 0.11 | 1000 | 41 | 1.4 | 5.8 |
| Example 5 | DINP | 0.11 | 3000 | 47 | 1.5 | 21.0 |
| Example 6 | DINP | 0.11 | 5000 | 49 | 1.4 | 47.8 |
| Example 7 | DINP | 0.11 | 7000 | 45 | 1.3 | — |
| Example 8 | DINP | 0.15 | 1000 | 40 | 1.4 | 5.4 |
| Example 9 | DINP | 0.20 | 1000 | 35 | 1.6 | 7.2 |
| Example 10 | DIDP | 0.15 | 1000 | 41 | 1.5 | 5.5 |
| Example 11 | DIDP | 0.20 | 1000 | 39 | 1.6 | 7.6 |
| Com. Example 1 | DIBP | 0.15 | 1000 | 33 | 1.8 | 4.5 |
| Com. Example 2 | DIBP | 0.15 | 3000 | 37 | 1.7 | 17.0 |
| Com. Example 3 | DIBP | 0.15 | 5000 | 39 | 1.8 | 42.0 |
| Com. Example 4 | DIBP | 0.15 | 7000 | 38 | 1.8 | — |
| Com. Example 5 | DIBP | 0.20 | 1000 | 32 | 1.9 | 5.2 |
| Com. Example 6 | DEP | 0.09 | 1000 | 31 | 1.8 | 4.2 |
| Com. Example 7 | DEP | 0.15 | 1000 | 33 | 1.9 | 4.9 |
| Com. Example 8 | DEP | 0.20 | 1000 | 27 | 2.1 | 4.7 |

(1) DINP: diisononyl phthalate
(2) DIDP: diisodecyl phthalate
(3) DTDP: di-tert-decyl phthalate
(4) DIBP: diisobutyl phthalate
(5) DEP: diethyl phthalate

### INDUSTRIAL APPLICABILITY

A catalyst obtained by a preparation method of a solid titanium catalyst for olefin polymerization according to the present invention has a uniform spherical shape, excellent catalyst activity and hydrogen reactivity, and high stereoregularity. Further, polymers prepared by using the catalyst have a small amount of xylene solubles, thereby increasing the productivity of a polymerization process.

1. A preparation method of a solid titanium catalyst for olefin polymerization comprising the steps of:
(1) obtaining a magnesium compound solution by dissolving a magnesium halide compound in an oxygen-containing solvent that is a mixed solvent of a cyclic ether and at least one of alcohols;
(2) preparing a carrier by primarily reacting the obtained magnesium compound solution with a titanium halide compound at −10-30° C., then raising a temperature or aging so as to obtain particles, and secondly reacting the particles with a titanium halide compound;
(3) preparing a catalyst by reacting the carrier with a titanium halide compound and phthalic acid dialkylester having C9-13 alkyl groups as an electron donor; and
(4) washing the prepared catalyst with a hydrocarbon solvent at 40-200° C.

2. The preparation method of a solid titanium catalyst for olefin polymerization according to claim 1, wherein the amount of oxygen-containing solvent in the step (1) is 1-15 mol per 1 mol of magnesium atoms contained in the magnesium halide compound.

3. The preparation method of a solid titanium catalyst for olefin polymerization according to claim 1, wherein the titanium halide compound in the step (2) is a compound of a general formula (I):
Ti(OR)ₙX₍₄₋ₐ₎ (I)
wherein R is a C1-10 alkyl group; X is a halogen atom, and; a is an integer of 0-3.

4. The preparation method of a solid titanium catalyst for olefin polymerization according to claim 1, wherein the electron donor, phthalic acid dialkylester having C9-13 alkyl groups in the step (3) is diisononylphthalate, diisodecylphthalate or di-tert-decylphthalate.
